(19) United States
(12) Patent Application Publication
(10) Pub. No.: US 2004/0267761 A1
(43) Pub. Date: Dec. 30, 2004

(54) Method/apparatus for managing information including word codes

(76) Inventors: Jiang-Liang Hou, Hsinchu City (TW); Ming-Tsong Sun, Luizu Shiang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/601,955

(22) Filed: Jun. 23, 2003

(51) Int. Cl. G06F 7/00

(52) U.S. Cl. 707/100

(57) ABSTRACT

This disclosure suggests a set of solutions to the bottle-necks in managing knowledge distribution/sharing. It is particularly powerful when applied to a system working with the Internet. Working together with keyword extraction rules, the solutions include a method/apparatus based on access authorization records related to issuers or providers of documents, categories of documents, crucial key words of documents, and feedbacks from authorized document receivers, for selecting at least an organizational unit (or person) to be an authorized unit (or person) having access to an object document. The art also features combining at least two of three access authorization records. Furthermore the art also features combining at least two of four sub-processes.

### FIELD OF THE INVENTION

The present invention generally relates to a method/apparatus of managing data/information/documents containing word codes, and particularly to a method/apparatus of authorizing at least one of a group to have access to an object document.

### BACKGROUND OF THE INVENTION

Pretty much effort has been made by many to transform paper-based data/information/documents into electronic files. This is particularly obvious now that Internet and various networks are popularly used for communicating data/infommation/documents among people, organizations, and nations, and that the technology to recognize scanned words provides satisfactory performance. Although a variety of methods/systems for managing electronic files have been developed to raise the efficiency and reliability of transmitting and sharing data/information/documents, one with ideal schemes for authorizing at least one of multiple function-units to have access to an object document is still expected.

Usually the access authorization of a document is determined by the issuer (or writer) of the document, resulting inevitably in uncontrolled or inconsistent or disorderly authorization of access to information (or data, or documents) of an organization or a government agency, and very likely leading to exposure of sensitive information to unconcerned people or even those linking competitors, and certainly leading to extra but meaningless communication among the function-units of the organization or agency. This can be understood from the fact that an issuer (or writer) of a document in an organization is unlikely capable of familiarizing the function or duty of each function-unit of an organization, not to mention knowing the sensitivity or confidential importance of each piece of information in the organization. The redundant communication resulting from uncontrolled or disorderly authorization of access to information (or data, or documents), not only occupy the capacity of communication channel, but also add extra work load to the function-units which are supposed to strain off irrelevant data/information/documents from the bulky material they receive all the time.

Although consistent or controllable access authorization of documents may be achieved by charging one or more than one administration staff with responsibility of access authorization of all the documents, too much reliance on human being's knowledge, experience, caution, stable mood, and constant or consistent criteria for making judgments constitutes critical problem. Although the access authorization means of U.S. Pat. No. 6,237,099 is more or less related to access authorization of documents, it is for inquiring an authorization system specified by the user and gaining authorization of the user, wherein the authorization system is inquired about who the user is according to the user name and password specified by the user. No any prior art has ever been known to substantially address the aforementioned issues of access authorization of documents. This is why a method/system providing for ideal access authorization of documents (or data/information) on the basis of automation or computer processing is broadly expected now and will even be more in the future.

### SUMMARY OF THE INVENTION

Definition

The phrase “having access to an object document” in the disclosure means “having an opportunity to read or use or save or receive or modify or delete or forward an object document”, or means “allowed to read or use or save or receive or modify or delete or forward an object document”.

The phrase “word code(s)” in the disclosure means “one or more than one symbol which can be inputted to a machine or is readable by a machine and/or human being”. For example, English word “a” or “people” or “security”, or English phrase “cost control” or “material acquisition”, etc are word code(s) according to the disclosure. Obviously any word(s) or phrase(s) in another language are also word code(s) according to the disclosure.

The word “function-unit” in the disclosure means “a person” or “a group of people” or “a machine” or “a system including more than one apparatus” or the combination thereof, as long as who/which can be expected to do anything.

The word “frequency” in a sentence like “the frequency one of the function-units has been authorized to have access to the documents provided by a known document-issuer” according to the disclosure, unless otherwise suggested, means a first times-number divided by a second times-number, with the first times-number being the times that the one function-unit has been authorized to have access to the documents provided by the known document-issuer, and the second times-number being the sum of the times that all the function-units have been authorized to have access to the documents provided by the known document-issuer, or the second times-number being the number of the documents provided by the known document-issuer.

The document-issuer-code in a document according to the disclosure means a code appearing in the document to indicate who issues (or provides) the document or where the document comes from.

The category-code in a document according to the disclosure means a code appearing in the document to indicate which category the document is in.

Objects

An object of the present invention is to provide a method/apparatus of managing documents (or data/information), for an organization or agency to promote its capability of adapting to knowledge based economy.

Another object of the present invention is to overcome the bottle-neck of achieving what is expected of processing documents (or data/information) electronically or systematically.

A further object of the present invention is to provide a method/apparatus of managing documents (or data/information), by which network communication can be better exploited by various organizations and enterprises to process their internal documents (or data/information).

Another further object of the present invention is to provide a method/apparatus of managing documents (or data/information), by which the information communication between different people, organizations, and enterprises can be more smooth and efficient while the trading-off of essential control of access authorization of documents (or data/information) can be avoided.

Still another further object of the present invention is to provide a method/apparatus of managing documents (or data/information), by which various people, organizations, and enterprises can manage documents (or data/information) in a way with less time consumption, lower cost, and minimum complication.

Operating Algorithm

The present invention features a process of access-authorization of document (or data/information). The present invention also features a process of category-classification of document (or data/information). The process of access-authorization of document (or data/information) according to one aspect of the present invention is to authorize, according to a reference-file, at least one of multiple function-units (different divisions or departments or project teams or employees of an organization, for example) to be an authorized function-unit having access to an object document which is in a known category and provided by a known document-issuer, wherein the document includes plural word codes, and the reference-file is a file recording history of access authorization of documents, or specifically a file recording the frequency/times each function-unit has been authorized to have access to the documents in the known category and/or provided by the known document-issuer. Alternatively the reference-file is a file recording the frequency/times each function-unit has been authorized to have access to the documents bearing at least an attribute representing the known document-issuer and/or the known category. The frequency/times a function-unit has been authorized to have access to the documents in the known category and/or provided by the known document-issuer, represents the probability that an object document in the known category and/or provided by the known document-issuer will be relevant to the function-unit, and therefore represents the weight toward authorizing the function-unit to have access to the object document. A document may also bear an attribute such as one or more than one crucial key word code characterizing the content of the document.

The process of access-authorization of document (or data/information) according to the aspect of the present invention above comprises at least one of the following three sub-processes:

(1). searching the reference-file for a first authorization-record including information about the frequency each of the function-units has been authorized to have access to the documents provided by the known document-issuer, and selecting, according to the first authorization-record, at least one of the function-units to be the authorized function-unit (the authorized function-unit here is the function-unit authorized to have access to the object document), wherein the first authorization-record includes a group of numbers (also called “frequency-numbers” or “times-numbers” in this disclosure) each representing the frequency (or times) that a different one of the function-units has been authorized to have access to the documents provided by the known document-issuer;

(2). searching the reference-file for a second authorization-record including information about the frequency each of the function-units has been authorized to have access to the documents in the known category, and selecting, according to the second authorization-record, at least one of the function-units to be the authorized function-unit (the authorized function-unit here is the function-unit authorized to have access to the object document), wherein the second authorization-record includes a group of numbers (also called “frequency-numbers” or “times-numbers” in this disclosure) each representing the frequency (or times) that a different one of the function-units has been authorized to have access to the documents in the known category; and

(3). identifying at least a crucial key word code from the object document, searching the reference-file for a third authorization-record including information about the frequency each of the function-units has been authorized to have access to the documents including the crucial key word code, and selecting, according to the third authorization-record, at least one of the function-units to be the authorized function-unit (the authorized function-unit here is the function-unit authorized to have access to the object document), wherein the third authorization-record includes a group of numbers (also called “frequency-numbers” or “times-numbers” in this disclosure) each representing the frequency (or times) that a different one of the function-units has been authorized to have access to the documents including the crucial key word code.

The process of access-authorization of document (or data/information) according to another aspect of the present invention is to authorize, according to a reference-file, at least one of multiple function-units to be an authorized function-unit having access to an object document including plural word codes, and is characterized by comprising at least one of the following three sub-processes:

(a). identifying a document-issuer-code (or document-provider-code) from the object document, searching the reference-file for a first authorization-record including information about the frequency each of the function-units has been authorized to have access to the documents including the document-issuer-code (or document-provider-code), and selecting, according to the first authorization-record, at least one of the function-units to be the authorized function-unit (the authorized function-unit here is the function-unit authorized to have access to the object document), wherein the first authorization-record includes a group of numbers (also called “frequency-numbers” or “times-numbers” in this disclosure) each representing the frequency that a different one of the function-units has been authorized to have access to the documents including the document-issuer-code (or document-provider-code);

(b). identifying a category-code from the object document, searching the reference-file for a second authorization-record including information about the frequency each of the function-units has been authorized to have access to the documents including the category-code, and selecting, according to the second authorization-record, at least one the function-unit to be the authorized function-unit (the authorized function-unit here is the function-unit authorized to have access to the object document), wherein the second authorization-record includes a group of numbers (also called “frequency-numbers” or “times-numbers” in this disclosure) each representing the frequency that a different one of the function-units has been authorized to have access to the documents including the category-code; and

(c). identifying at least a crucial key word code from the object document, searching the reference-file for a third authorization-record including information about the frequency each of the function-units has been authorized to have access to the documents including the crucial key word code, and selecting, according to the third authorization-record, at least one of the function-units to be the authorized function-unit (the authorized function-unit here is the function-unit authorized to have access to the object document), wherein the third authorization-record includes a group of numbers (also called “frequency-numbers” or “times-numbers” in this disclosure) each representing the frequency that a different one of the function-units has been authorized to have access to the documents including the crucial key word code.

According to the present invention, the step of selecting at least one function-unit to be the authorized function-unit according to the authorization-record, may comprise: comparing each frequency-number (or times-number) included in the authorization-record to a criteria-frequency-number (or criteria-times-number) to identify each of the function-units which has been authorized for at least a frequency represented by the criteria-frequency-number (or criteria-times-number) to have access to the documents including the same document-issuer-code (or document-provider-code) or category-code or crucial key word code as the object document does, thereby the identified function-unit is the function-unit authorized to have access to the object document. For example, the step of selecting at least one function-unit to be the authorized function-unit according to the first authorization-record, comprises comparing each frequency-number (or times-number) included in the first authorization-record to a criteria-frequency-number (or criteria-times-number) to identify each of the function-units which has been authorized for at least a frequency represented by the criteria-frequency-number (or criteria-times-number) to have access to the documents including the same document-issuer-code (or document-provider-code) as the object document does. Similarly the step of selecting at least one function-unit to be the authorized function-unit according to the second (or third) authorization-record, comprises comparing each frequency-number (or times-number) included in the second (or third) authorization-record to a criteria-frequency-number (or criteria-times-number) to identify each of the function-units which has been authorized for at least a frequency represented by the criteria-frequency-number to have access to the documents including the same category-code (or crucial key word code) as the object document does.

According to the present invention, an alternative to the step of selecting at least one function-unit to be the authorized function-unit according to the authorization-record, comprise: identifying each frequency-number (or times-number) which is included in the authorization record and which, in order of magnitude among all the frequency-numbers (or times-number) included in the authorization record, is within a criteria range (a criteria range of 1-2 means the biggest and the second biggest in order of magnitude among all the frequency-numbers, for example); and identifying each of the function-units which has been authorized for the identified frequency-number (or times-number) to have access to the documents including the same document-issuer-code (or document-provider-code) or category-code or crucial key word code as the object document does, thereby the identified function-unit is the function-unit authorized to have access to the object document. For example, an alternative to the step of selecting at least one function-unit to be the authorized function-unit according to the first authorization-record, comprises: identifying each frequency-number (or times-number) which is included in the first authorization record and which, in order of magnitude among all the frequency-numbers (or times-numbers) included in the first authorization record, is within a criteria range (the biggest in order of magnitude among all the frequency-numbers, for example); and identifying each of the function-units which has been authorized for the identified frequency-number (or times-number) to have access to the documents including the same document-issuer-code (or document-provider-code) as the object document does. Similarly an alternative to the step of selecting at least one function-unit to be the authorized function-unit according to the second (or third) authorization-record, comprises: identifying each frequency-number (or times-number) which is included in the second (or third) authorization record and which, in order of magnitude among all the frequency-numbers (or times-numbers) included in the second (or third) authorization record, is within a criteria range (a criteria range of 1-3 means at least the third biggest in order of magnitude among all the frequency-numbers, for example); and identifying each of the function-units which has been authorized for the identified frequency-number (or times-number) to have access to the documents including the same category-code (or crucial key word code) as the object document does.

The process of access-authorization of document (or data/information) according to the present invention may be configured to be on the basis of referring to the mathematical combination of two or more than two authorization-records with a weight value of each authorization-record taken into consideration, wherein the weight value of the first authorization-record represents the importance, in the selection of a function-unit to have access to the object document, of the frequency-numbers (or times-numbers) in the first authorization-record with respect to those in the other authorization-records, and the weight value of the second or third authorization-record represents the importance, in the selection of a function-unit to have access to the object document, of the frequency-numbers (or times-numbers) in the second or third authorization-record with respect to those in the other authorization-records. The process of access-authorization of document (or data/information) according to the present invention so configured comprises at least two of the following three steps (A), (B), and (C), in addition to step (D):

(A). performing a first mathematical operation (multiplication, for example) between a provider weight value and the frequency-numbers (or times-numbers) included in the first authorization-record to obtain a group of provider-based authorization-reference values respectively corresponding to the different ones of the function-units, i.e., each of the provider-based authorization-reference values comes from the first mathematical operation between a provider weight value and a frequency-number (or times-number) representing the frequency (or times) a function-unit has been authorized to have access to the documents provided by the known document-issuer (or the documents including the same document-issuer-code or document-provider-code as the object document does), thereby each of the provider-based authorization-reference values corresponds to a different one of the function-units;

(B). performing the first mathematical operation between a category weight value and the frequency-numbers (or times-number) included in the second authorization-record to obtain a group of category-based authorization-reference values respectively corresponding to different ones of the function-units, i.e., each of the category-based authorization-reference values comes from the first mathematical operation between a category weight value and a frequency-number (or times-number) representing the frequency (or times) a function-unit has been authorized to have access to the documents in the known category (or the documents including the same category-code as the object document does), thereby each of the category-based authorization-reference values corresponds to a different one of the function-units;

(C). performing the first mathematical operation between a crucial-key-word weight value and the frequency-numbers included in the third authorization-record to obtain a group of crucial-key-word-based authorization-reference values respectively corresponding to different ones of the function-units, i.e., each of the crucial-key-word-based authorization-reference values comes from the first mathematical operation between a crucial-key-word weight value and a frequency-number (or times-number) representing the frequency (or times) a function-unit has been authorized to have access to the documents including the same crucial key word code as the object document does, thereby each of the crucial-key-word-based authorization-reference values corresponds to a different one of the function-units;

(D). selecting, according to at least two of the three groups of the authorization-reference values, at least one of the function-units to have access to the object document, wherein the three groups of the authorization-reference values are provider-based authorization-reference values, category-based authorization-reference values, and crucial-key-word-based authorization-reference values. The step (D) above comprises:

performing a second mathematical operation (addition, for example) between the authorization-reference values which are respectively in different groups of the authorization-reference values but correspond to the same one of the function-units, to obtain a group of compound-reference values respectively corresponding to different ones of the function-units; and

comparing the compound-reference values with a compound-reference-criteria value to identify each of the function-units corresponded by one of the compound-reference values larger than the compound-reference-criteria value, whereby each of the identified function-units is selected to have access to the object document.

Performing the second mathematical operation to obtain the group of compound-reference values, for example, may be such that the one which is in a first group of the authorization-reference values and corresponds to an arbitrary function-unit is added to the other one which is in a second groups of the authorization-reference values and corresponds to the arbitrary function-unit, to obtain one of the compound-reference values, or that the three which are respectively in the three groups of the authorization-reference values and correspond to the same function-unit are added together, to obtain one of the compound-reference values. Performing the addition one by one for each of the function-units, all the compound-reference values are obtained.

An alternative to the step (D) above is such that the identified function-units are those corresponded by the compound-reference values which, in order of magnitude among all the compound-reference values, are within a compound-reference-criteria-range (a compound-reference-criteria-range 1-3 means at least the third biggest in order of magnitude among all the compound-reference values, for example).

A further aspect of the present invention is an apparatus applied to an information management system in which at least one of multiple function-units is selected to be an authorized function-unit having access to an object document that includes word codes, is in a known category, and is provided by a known document-issuer. The apparatus comprises a data-storage portion having a database residing thereon, with the database comprising: a first authorization-record including the frequency-numbers each representing the frequency that a different one of the function-units has been selected to have access to the documents provided by the known document-issuer; and/or a second authorization-record including the frequency-numbers each representing the frequency that a different one of the function-units has been selected to have access to the documents in the known category; and/or a third authorization-record including the frequency-numbers each representing the frequency that a different one of the function-units has been selected to have access to the documents including at least a crucial key word code of the object document.

The apparatus above may comprise an operational portion which is configured to select, according to at least one of the three authorization-records, at least one of the function-units to be an authorized function-unit having access to the object document, as described above. Obviously the data-storage portion above may be an ordinary memory readable by the operational portion, and/or compatible with ordinary input/output devices.

The present invention may best be understood through the following description with reference to the accompanying drawings, in which:

### BRIEF DESCRIPTION OF THE DRAWINGS

FIG. 1 is a flow chart showing some optional ways for embodying a process of access authorization of documents according to the present invention.

FIG. 2 shows a table illustrating some steps in an embodiment example of a process of access authorization of documents according to the present invention.

FIG. 3 shows a schematic view of an embodiment example of apparatus provided according to the present invention.

### DETAILED DESCRIPTION OF THE PREFERRED EMBODIMENTS

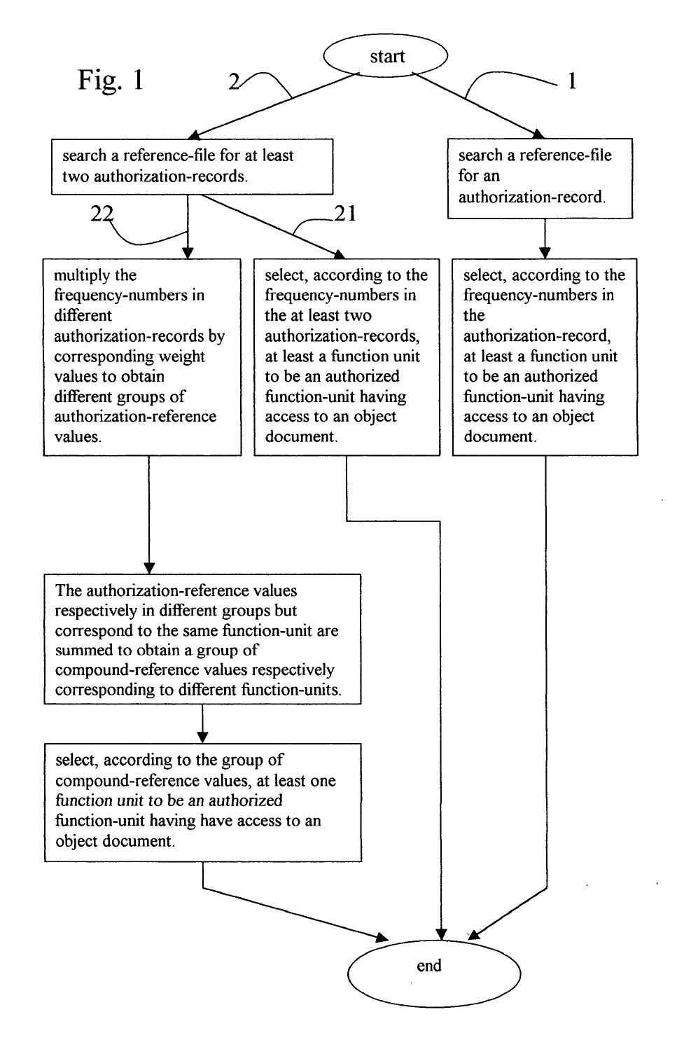

In FIG. 1, a first optional way 1 to embody a process of access-authorization of document (or data/information) according to the present invention is to search a reference-file for an authorization-record, and then select, according to the frequency-numbers in the authorization-record, at least a function-unit to be an authorized function-unit having access to an object document; and a second optional way 2 to embody a process of access-authorization of document (or data/information) according to the present invention is to search a reference-file for at least two authorization-records, followed by either an optional way 21 or 22. The optional way 21 is to select, according to the frequency-numbers in the at least two authorization-records, at least a function-unit to be an authorized function-unit having access to an object document. The optional way 22 is to multiply the frequency-numbers in different authorization-records by corresponding weight values (one weight value corresponds to the frequency-numbers in one authorization-record), to obtain different groups of authorization-reference values. The authorization-reference values respectively in different groups but correspond to the same function-unit are summed to obtain a group of compound-reference values respectively corresponding to different function-units, and at least one function-unit is then selected, according to the group of compound-reference values, to be an authorized function-unit having have access to an object document.

One preferred embodiment of the present invention is a method including a process of access-authorization of document (or data/information), which is to authorize, according to a reference-file, at least one of multiple function-units (different divisions or departments or project teams or employees of an organization, for example) to be an authorized function-unit having access to an object document which is in a known category and provided by a known document-issuer. The embodiment of the process of access-authorization is based on the availability of the reference-file which has recorded history of access authorization of documents (or data/information). For example, the reference-file contains at least one of three groups of data, the first group being frequency-numbers each representing the frequency that a different one of the function-units of an organization (or agency) has been selected to have access to the documents provided by the known document-issuer, the second group being frequency-numbers each representing the frequency that a different one of the function-units of the organization (or agency) has been selected to have access to the documents in the known document-category, and the third group being frequency-numbers each representing the frequency that a different one of the function-units of an organization (or agency) has been selected to have access to the documents including at least a crucial key word code of the object document, wherein the crucial key word code is a key word

in the abstract of the object document, and is a word characterizing the content of the object document. The crucial key word code of the object document (or an arbitrary document) may be selected by the known document-issuer (or the issuer or provider of the arbitrary document) from the abstract of the object document (or the arbitrary document). The reference-file is so configured that the first group of the data is included in a first authorization-record thereof, the second group of the data is included in a second authorization-record thereof, and the third group of the data is included in a third authorization-record thereof, i.e., each frequency-number in the first authorization-record corresponds to a different one of the function-units, each frequency-number in the second or third authorization-record also corresponds to a different one of the function-units.

The process of access-authorization according to the embodiment of the present invention above comprises: comparing the frequency-numbers included in the selected authorization-record to a criteria-frequency-number, to identify each of the function-units which is corresponded by a frequency-number at least equivalent to (larger than or equal to) the criteria-frequency-number, i.e., to identify, in case the selected authorization-record is the first authorization-record, each of the function-units which has been authorized, for a frequency represented by the criteria-frequency-number or a bigger one, to have access to the documents provided by the known document-issuer; or to identify, in case the selected authorization-record is the second authorization-record, each of the function-units which has been authorized, for a frequency represented by the criteria-frequency-number or a bigger one, to have access to the documents in the known document-category; or to identify, in case the selected authorization-record is the third authorization-record, each of the function-units which has been authorized, for a frequency represented by the criteria-frequency-number or a bigger one, to have access to the documents including at least a crucial key word code of the object document. The one or more than one function-unit so identified above is selected to be the authorized function-unit having access to the object document. The criteria-frequency-number may be assigned (or configured) in the beginning or any time before being compared with the frequency-numbers.

In case more than one authorization-record is selected to be the reference for authorizing function-units to have access to the object document, the same or different criteria-frequency-numbers (or criteria-times-numbers) may be assigned to respectively correspond to the different selected authorization-records (i.e., to correspond to more than one group among the three groups of data), and the embodiment of the present invention is so configured that a function-unit is selected to be the authorized function-unit having access to the object document whenever it is corresponded by a frequency-number or times-number (no matter which authorization-record it is included in) at least equivalent to (larger than or equal to) any one of the criteria-frequency-numbers (or criteria-times-numbers). An alternative is that a function-unit is selected to be the authorized function-unit having access to the object document only when it is corresponded by a frequency-number or times-number (no matter which authorization-record it is included in) at least equivalent to (larger than or equal to) all the criteria-frequency-numbers (or criteria-times-numbers).

The process of access-authorization according to the embodiment of the present invention above can be further understood by the following example. Assume the second authorization-record is selected to be the sole reference for authorizing function-units to have access to the object document, and a criteria-frequency-number 0.8 is assigned (or configured) to correspond to the second authorization-record, according to which function-units A and B have been respectively authorized, for frequencies represented by 0.85 and 0.9, to have access to the documents in the category of “production cost”, the function-units A and B will be automatically selected to be the authorized function-units having access to any object document classified in the category of “production cost”, i.e., whenever an object document is in the category of “production cost”, function-units A and B will be automatically authorized to have access to the object document.

Alternatively assume the third authorization-record is selected to be the sole reference for authorizing function-units to have access to the object document, and a criteria-times-number 8 is assigned (or configured) to correspond to the third authorization-record, according to which function-units A and B have been respectively authorized for 10 and 13 times to have access to the documents including crucial key word codes “security control” that also are the crucial key word codes of the object document, the function-units A and B will be automatically selected to be the authorized function-units having access to any object document including crucial key word codes “security control”, i.e., whenever an object document includes “security control” as the crucial key word codes thereof, the function-units A and B will be automatically authorized to have access to the object document.

Alternatively assume otherwise the first authorization-record is selected to be the sole reference for authorizing function-units to have access to the object document, and a criteria-frequency-number 0.8 is assigned (or configured) to correspond to the first authorization-record, according to which function-units B and C have been respectively authorized, for frequencies represented by 0.73 and 0.86, to have access to the documents provided by the document-issuer “finance department”, the function-units C will be automatically selected to be the authorized function-units having access to any object document provided by the document-issuer “finance department”, while function-unit B, given that the first authorization-record is selected to be the sole reference for authorizing function-units to have access to the object document, will not be automatically selected to be the authorized function-units having access to the object document provided by the document-issuer “finance department”. However, the present invention may be so configured that more than one authorization-record instead of only one authorization-record is selected to be the reference for authorizing function-units to have access to the object document, and function-unit B under such a condition may still be automatically selected to be the authorized function-units having access to the object document even though it does not meet the condition of being selected on the basis of referring only to the first authorization-record. For example, in case both the first and second authorization-records are selected to be the reference for authorizing function-units to have access to the object document, criteria-frequency-numbers 0.8 and 0.95 are respectively (not necessarily different) assigned to the selected first and second authorization-records, and the embodiment of the present invention is so configured that a function-unit is selected to be the authorized function-unit having access to the object document whenever it is corresponded by a frequency-number (no matter which authorization-record it is included in) at least equivalent to (larger than or equal to) the biggest one (0.95 for this case) of the criteria-frequency-numbers, function-unit B will still be automatically selected to be the authorized function-units having access to the object document if it is corresponded by a frequency-number which is in the selected second authorization-record and is at least equivalent to (larger than or equal to) 0.95.

The access-authorization process according to the embodiment of the present invention above may further comprise a verification sub-process for verifying if all the authorized function-units are properly selected. The verification sub-process comprises: forming a list to contain all the authorized function-units; requesting a response of the authorized function-units to the object document, for example, requesting the authorized function-units to issue replies about their receiving of the object document; and modifying the list according to the response, for example, some of the authorized function-units may issue replies claiming that the object document is not relevant to them, and the list is modified accordingly.

Another aspect of the access-authorization process according to the embodiment of the present invention above is based on referring to the mathematical combination of two or more than two authorization-records and taking into consideration the weight values respectively representing the importance of authorization-records with respect to each other. The access-authorization process comprises at least two of the following three steps (a), (b), and (c), in addition to step (d), and can be further understood by examples after describing the four steps:

(a) performing a first mathematical operation such as multiplication between a provider weight value and the frequency-numbers included in the first authorization-record to obtain a group of provider-based authorization-reference values respectively corresponding to different ones of the function-units, for example, if the provider weight value is 0.3, all frequency-numbers included in the first authorization-record are multiplied by 0.3 to obtain the group of provider-based authorization-reference values, thereby each of the provider-based authorization-reference values corresponds to a different one of the frequency-numbers included in the first authorization-record, i.e., the frequency that an arbitrary function-unit has been authorized to have access to the documents provided by the known document-issuer (the document-issuer providing the object document) weighs 0.3 towards selecting the arbitrary function-unit to be the authorized one having access to the object document.

(b) performing the first mathematical operation between a category weight value and the frequency-numbers included in the second authorization-record to obtain a group of category-based authorization-reference values respectively corresponding to different ones of the function-units, for example, if the category weight value is 0.5, all frequency-numbers included in the second authorization-record are multiplied by 0.5 to obtain the group of category-based authorization-reference values, thereby each of the category-based authorization-reference values corresponds to a different one of the frequency-numbers included in the second authorization-record, i.e., the frequency that an arbitrary function-unit has been authorized to have access to the documents in the known category (the category which the object document is in) weighs 0.5 towards selecting the arbitrary function-unit to be the authorized one having access to the object document;

(c) performing the first mathematical operation between a crucial-key-word weight value and the frequency-numbers included in the third authorization-record to obtain a group of crucial-key-word-based authorization-reference values respectively corresponding to different ones of the function-units, for example, if the crucial-key-word weight value is 0.2, all frequency-numbers included in the third authorization-record are multiplied by 0.2 to obtain the group of crucial-key-word-based authorization-reference values, thereby each of the crucial-key-word-based authorization-reference values corresponds to a different one of the frequency-numbers included in the third authorization-record, i.e., the frequency that an arbitrary function-unit has been authorized to have access to the documents including at least a crucial key word code of the object document weighs 0.2 towards selecting the arbitrary function-unit to be the authorized one having access to the object document; and

(d) selecting, according to at least two of the three groups of the authorization-reference values, at least one of the function-units to have access to the object document, for example, if the selection of the authorized function-unit is based on referring to the first and second groups of the authorization-reference values, a second mathematical operation such as addition is performed between every two authorization-reference values which are respectively in the first and second groups of the authorization-reference values and correspond to the same one of the function-units, to obtain a group of compound-reference values respectively corresponding to different ones of the function-units, i.e., if the provider-based authorization-reference value corresponding to an arbitrary function-unit (such as “Financial Dept”) is 0.4, and the category-based authorization-reference value corresponding to the arbitrary function-unit “Financial Dept” is 0.3, the compound-reference value corresponding to the arbitrary function-unit “Financial Dept” is 0.3+0.4=0.7, and thereby is compared to a compound-reference-criteria value to check if it is larger than the compound-reference-criteria value. The arbitrary function-unit “Financial Dept” will be selected to be the authorized function-unit having access to the object document if the compound-reference value (=0.7 in this example) corresponding to it is larger than the compound-reference-criteria value. For example, the arbitrary function-unit “Financial Dept” will be selected to be the authorized function-unit if the compound-reference-criteria value is 0.6, and shall not be selected to be the authorized function-unit if the compound-reference-criteria value is 0.75.

By comparing all the compound-reference values to the compound-reference-criteria value, each of the compound-reference values larger than the compound-reference-criteria value can be identified, thereby the function-units to be authorized to have access to the object document can be identified, i.e., each of the function-units corresponded by the compound-reference values larger than the compound-reference-criteria value is identified and selected to be an authorized function-unit having access to the object document. Alternatively all the compound-reference values are compared to one another, to identify each of the function-units corresponded by one of the compound-reference values which, in order of magnitude among all the compound-reference value, is in a compound-reference-criteria range, thereby the identified function-unit (one or more than one) is selected to be an authorized function-unit having access to the object document. For example, given that the compound-reference-criteria range is 1-3, and all the compound-reference values are 0.3, 0.45, 0.5, 0.4, 0.68, 0.55, 0.73, 0.84, 0.28, 0.9, 0.95, and 0.79. In order of magnitude, the list of all the compound-reference values is 0.95, 0.9, 0.84, 0.79, 0.73, 0.68, 0.55, 0.5, 0.45, 0.4, 0.3, 0.28 with 0.95, 0.9, 0.84 in the compound-reference-criteria range (1-3), thereby the function-units corresponded by the three compound-reference values 0.95, 0.9, and 0.84 are selected to be the authorized function-units having access to the object document.

If the selection of the authorized function-unit is based on referring to the three groups of the authorization-reference values, it is preferred that the sum of the provider weight value, the category weight value, and the crucial-key-word weight value is 1. If the selection of the authorized function-unit is based on referring to the first and second groups of the authorization-reference values, it is preferred that the sum of the provider weight value and the category weight value is 1. Similarly if the selection of the authorized function-unit is based on referring to the second and third groups of the authorization-reference values, it is preferred that the sum of the category weight value and the crucial-key-word weight value is 1.

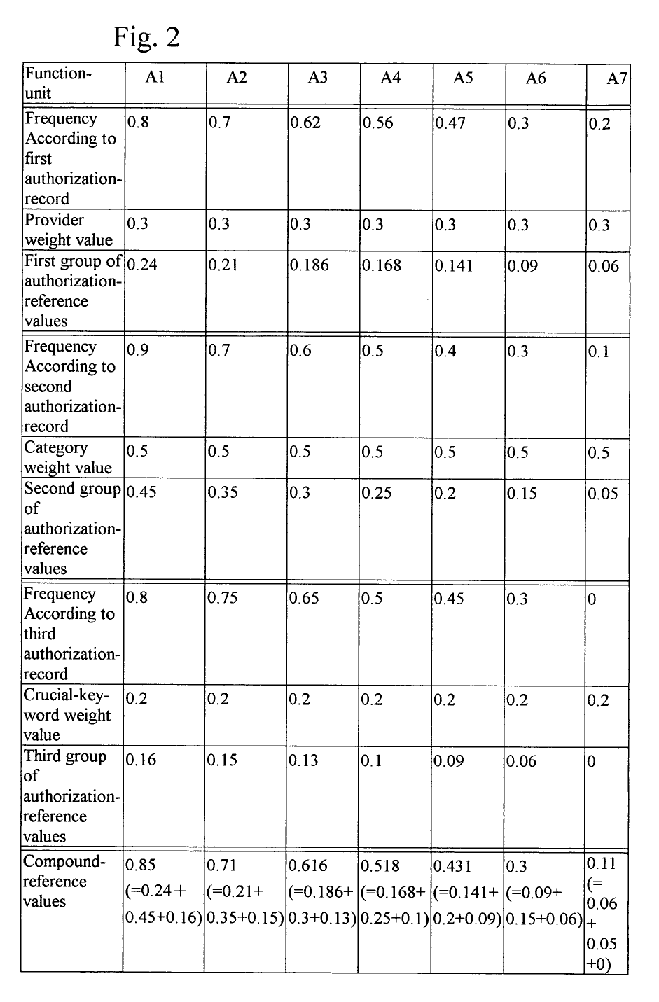

For better understanding, the following example is presented to further describe the access-authorization process according to the present invention. Here the selection of a function-unit to be the authorized function-unit having access to the object document, is to be on the basis of referring to the three groups of the authorization-reference values (obtained by computing the weight values and the three authorization-records in the reference-file, as described above), wherein the object document is in the category “production control”, is provided by a document-issuer “General Manager”, and includes a crucial key word code “cost”. The provider weight value, the category weight value, and the crucial-key-word weight value are respectively assumed to be 0.3, 0.5, and 0.2, and the compound-reference-criteria value assumed to be 0.7, the compound-reference-criteria range assumed to be 1-3. To select at least a function-unit to be the authorized function-unit having access to the object document, first the reference-file is searched for the three authorization-records, with the first authorization-record including frequency-numbers 0.8, 0.7, 0.62, 0.56, 0.47, 0.3, and 0.2 (shown in table of FIG. 2) respectively representing the frequencies that function-units A1, A2, A3, A4, A5, A6, and A7 have been selected to be the authorized function-units having access to the documents provided by the document-issuer “General Manager”, with the second authorization-record including frequency-numbers 0.9, 0.7, 0.6, 0.5, 0.4, 0.3, and 0.1 (shown in the table of FIG. 2) respectively representing the frequencies that function-units A1, A2, A3, A4, A5, A6, and A7 have been selected to be the authorized function-units having access to the documents in the category “production control”, and with the third authorization-record including frequency-numbers 0.8, 0.75, 0.65, 0.5, 0.45, 0.3, and 0 (shown in table of FIG. 2) respectively representing the frequencies that function-units A1, A2, A3, A4, A5, A6, and A7 have been selected to be the authorized function-unit having access to the documents including the crucial key word code “cost”. The frequency-numbers 0.8, 0.7, 0.62, 0.56, 0.47, 0.3, and 0.2 are then respectively multiplied by the provider weight value 0.3 to obtain the first group of authorization-reference values 0.24, 0.21, 0.186, 0.168, 0.141, 0.09, and 0.06 (shown in the table of FIG. 2), the frequency-numbers 0.9, 0.7, 0.6, 0.5, 0.4, 0.3, and 0.1 are then respectively multiplied by the category weight value 0.5 to obtain the second group of authorization-reference values 0.45, 0.35, 0.3, 0.25, 0.2, 0.15, and 0.05, and the frequency-numbers 0.8, 0.75, 0.65, 0.5, 0.45, 0.3, and 0 are then respectively multiplied by the crucial-key-word weight value 0.2 to obtain the third group of authorization-reference values 0.16, 0.15, 0.13, 0.1, 0.09, 0.06, and 0 (all shown in the table of FIG. 2). Now every three authorization-reference values respectively in the three groups and respectively correspond to the same function-unit are summed to obtain the compound-reference values 0.85 (=0.24+0.45+0.16), 0.71 (=0.21+0.35+0.15), 0.616 (=0.186+0.3+0.13), 0.518 (=0.168+0.25+0.1), 0.431 (=0.141+0.2+0.09), 0.3 (=0.09+0.15+0.06), and 0.11 (=0.06+0.05+0) each corresponding to a different one of the function-units A1, A2, A3, A4, A5, A6, and A7 (also shown in the table of FIG. 2). Because the compound-reference-criteria value is 0.7, function-units A1 and A2 are selected to be the authorized function-units having access to the object documents, if the compound-reference-criteria value 0.7 is the sole criteria for the selection. Alternatively, if the compound-reference-criteria range 1-3 is the sole criteria for the selection, function-units A1, A2, and A3 are selected to be the authorized function-unit having access to the object documents, because 0.85, 0.71, and 0.616 are within the compound-reference-criteria range 1-3 in order of magnitude among all the compound-reference values 0.85, 0.71, 0.616, 0.518, 0.431, 0.3, and 0.11. Obviously in case the selection of authorized function-unit having access to the object document is based on referring only to two groups of the authorization-reference values, only two authorization-records need to be searched from the reference-file, and the reference-file needs to contain only two authorization-records.

The present invention further comprises a category-classification process for classifying documents, thereby the object document is put in the known category, and/or any document is put in a proper category, contributing to the preparation of the second authorization-record in the reference-file. An embodiment of the category-classification process according to the present invention comprises: identifying at least a key word code (such as “production schedule” or “cost” or “material acquisition” or “investment risk” or “security”, etc) of the object document; and designating (or entitling) the known category (such as “production control” or “investment”, etc) according to the identified key word code. For example, a key-word-code-to-category-mapping table containing a list of key word codes and a list of category-codes is searched for a category-code corresponding to the identified key word code, whereby the known category is designated (or entitled) the category-code. According to the category-classification process provided by the present invention and described above, designating the known category according to the identified key word code, may further comprise notifying (or requesting a response from) the known document-issuer (or document-provider) if more than one category-code is searched out of the key-word-code-to-category-mapping table to correspond to the identified key word code. The known document-issuer (or document-provider) may be expected to help decide which category-code had better be chosen.

According to the category-classification process provided by the present invention and described above, the key word code of the object document (and/or the other documents) is identified by: counting the frequency each word code of the object document appears in the object document, to obtain an appearing frequency of each word code of the object document; designating an arbitrary word code of the object document as a candidate key word code if the appearing frequency of the arbitrary word code meets a reference condition; searching a key-word-reference database for a reference code corresponding to the candidate key word code; and determining, in case the reference code is searched out, whether or not the candidate key word code is a key word code according to an attribute of the reference code. The aforementioned reference condition means “larger than a key-word-criteria value”, i.e., the arbitrary word code of the object document is designated as a candidate key word code if the appearing frequency of the arbitrary word code is larger than the key-word-criteria value (0.9 or 0.73, just for example). One way to choose the key-word-criteria value is to let it equal to the average of the appearing frequencies of all the word codes of the object document. Alternatively the aforementioned reference condition means “within a frequency-order-criteria-range”, i.e., the arbitrary word code of the object document is designated as a candidate key word code if the appearing frequency of the arbitrary word code, in order of magnitude among the appearing frequencies of all the word codes of the object document, is within a frequency-order-criteria-range. For example, in case the frequency-order-criteria-range is 1-2, and the appearing frequencies of all the word codes of the object document are 0.3, 0.65, 0.5, 0.7, 0.4, 0.8, 0.75, 0.85, and many others lower than 0.3, the arbitrary word code of the object document is designated as a candidate key word code if the appearing frequency of the arbitrary word code is the highest (0.85 in this case) or the second highest one (0.8 in this case) among all the appearing frequencies.

According to the category-classification process provided by the present invention and described above, the key-word-reference database is configured to contain a plurality of reference codes. The reference code corresponding to a candidate key word code includes the candidate key word code. The reference code also includes an attribute represented by a first symbol or a second symbol. The candidate key word code is determined to be a key word code if the attribute of the reference code is represented by the first symbol, while determined to be not a key word code if the attribute of the reference code is represented by the second symbol. For example, if the candidate key word code is the words “investment risk” and the reference code is “investment risk +” with its attribute represented by a first symbol “+”, the candidate key word code is determined to be a key word code, while determined to be not a key word code if the reference code is “investment risk −” with its attribute represented by a second symbol “−”. The reference code may include one or more than word in addition to an attribute.

Alternatively the category-classification process provided by the present invention may be so configured that the candidate key word code is determined to be a key word code unless the attribute of the reference code is represented by the second symbol. Another alternative is that the candidate key word code is determined to be a key word code unless the reference code includes any symbol in addition to the candidate key word code, or vice versa.

According to the category-classification process provided by the present invention and described above, the key-word-reference database may otherwise be configured to include a key-word-code list and a non-key-word-code list, the candidate key word code is determined to be a key word code if the reference code is on the key-word-code list, and is determined to be not a key word code if the reference code is on the non-key-word-code list.

According to the present invention described above, the frequency one of the function-units has been authorized to have access to the documents in the known category, is the times that one of the function-units has been authorized to have access to the documents in the known category, or alternatively is a first times-number divided by a second times-number, with the first times-number being the times that the one of the function-units has been authorized to have access to the documents in the known category, and the second times-number being the sum of the times that all the function-units have been authorized to have access to the documents in the known category. For example, if the times the function-unit A3 has been authorized to have access to the documents in the known category is 20 (first times-number=20 in this case), and the sun of the times that all the function-units have been authorized to have access to the documents in the known category is 35 (second times-number=35 in this case), the frequency the function-unit A3 has been authorized to have access to the documents in the known category, is 20/35 (the first times-number 20 divided by the second times-number 35).

Alternatively the frequency one of the function-units has been authorized to have access to the documents in the known category, may also be defined to be a first times-number divided by a second times-number, with the first times-number being the times that the one of the function-units has been authorized to have access to the documents in the known category, and the second times-number being the number of the documents in the known category. For example, if the times the function-unit A1 has been authorized to have access to the documents provided in the known category is 25 (first times-number=25 in this case), and the number of the documents in the known category is 36 (second times-number=36 in this case), the frequency the function-unit A1 has been authorized to have access to the documents in the known category, is 25/36 (the first times-number 25 divided by the second times-number 36).

Obviously the criteria-frequency-number, the compound-reference-criteria value, the compound-reference-criteria range, the key-word-criteria value, the frequency-order-criteria-range, the criteria-times-number, the key-word-code-to-category-mapping table, and the weight values may be configured, according to the present invention, in the beginning of running a process or any time before they are used.

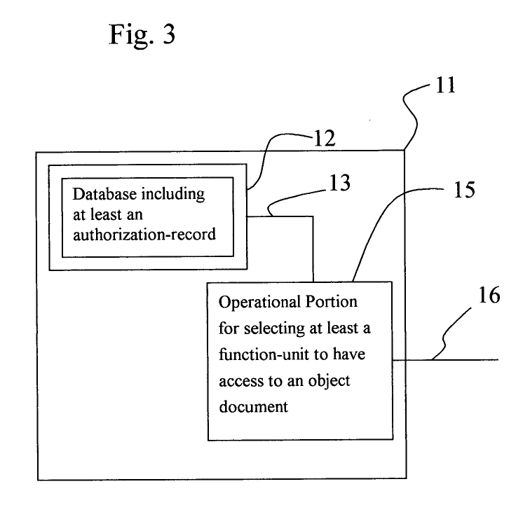

FIG. 3 shows a schematic view of an embodiment example of apparatus 11 provided by the present invention for an information management system, in which at least one of multiple function-units is selected to be an authorized function-unit having access to an object document that includes word codes, is in a known category, and is provided by a known document-issuer. The object document may further include at least a crucial key word code (a word code selected by the known document-issuer from the abstract of the object document, for example). The apparatus 11 comprises a data-storage portion 12 having a database residing thereon, an operating portion 15, and an access channel 13 for the operating portion 15 to access the database residing on the data-storage portion 12. The database residing on the data-storage portion 12 comprises: a first authorization-record including the frequency-numbers each representing the frequency that a different one of the function-units has been selected to have access to the documents provided by the known document-issuer; or/and a second authorization-record including the frequency-numbers each representing the frequency that a different one of the function-units has been selected to have access to the documents in the known category.

The database residing on data-storage portion 12 may further comprise a third authorization-record including the frequency-numbers each representing the frequency that a different one of the function-units has been selected to have access to the documents including at least a crucial key word code of the object document. The operating portion 15 is for running the process of access-authorization according to the present invention described above, i.e., is configured to select, according to at least one of the authorization-records residing on data-storage portion 12, at least one of the function-units to be an authorized function-unit having access to the object document. The operating portion 15 may be further for running the category-classification process provided by the present invention and described above.

Obviously the data-storage portion 12 may be a memory readable by the operational portion 15, and the apparatus 11 may further comprise a communication channel 16 for the operating portion 15 and/or the data-storage portion 12 to communicate with related administrator, and/or a computer, and/or Internet (or another networks), and/or function-units.

While the invention has been described in terms of what are presently considered to be the most practical or preferred configurations, it is not limited to the disclosure. On the contrary, it is to cover various modifications or similar arrangements suggested by the disclosure or included within the spirit and scope of the appended claims.

What is claimed is:

1. A method for managing information including word codes, comprising an access-authorization process for authorizing, according to a reference-file, at least one of multiple function-units to be an authorized function-unit having access to an object document which is in a known category and provided by a known document-issuer, said document including plural word codes, said access-authorization process comprising at least one of the following three sub-processes:
searching said reference-file for a first authorization-record including frequency-numbers each representing the frequency that a different one of said function-units has been authorized to have access to the documents provided by said known document-issuer, and selecting, according to said first authorization-record, at least one said function-unit to be said authorized function-unit;
searching said reference-file for a second authorization-record including the frequency-numbers each representing the frequency that a different one of said function-units has been authorized to have access to the documents in said known category, and selecting, according to said second authorization-record, at least one said function-unit to be said authorized function-unit; and
identifying at least a crucial key word code from said object document, searching said reference-file for a third authorization-record including the frequency-numbers each representing the frequency that a different one of said function-units has been authorized to have access to the documents including said crucial key word code, and selecting, according to said third authorization-record, at least one said function-unit to be said authorized function-unit.

2. The method according to claim 1 wherein said crucial key word code is a word code selected by said known document-issuer from the abstract of said document.

3. The method according to claim 1 wherein selecting, according to said first authorization-record, at least one said function-unit to have access to said object document, comprises:
comparing the frequency-numbers in said first authorization-record to a criteria-frequency-number, to identify each said function-unit which has been authorized, for at least a frequency represented by said criteria-frequency-number, to have access to the documents provided by said known document-issuer, whereby the identified function-unit is selected to have access to said object document.

4. The method according to claim 1 wherein selecting, according to said second authorization-record, at least one said function-unit to have access to said object document, comprises:
comparing the frequency-numbers in said second authorization-record to a criteria-frequency-number, to identify each said function-unit which has been authorized for at least a frequency represented by said criteria-frequency-number to have access to the documents in said known category, whereby the identified function-unit is selected to have access to said object document.

5. The method according to claim 1 wherein selecting, according to said third authorization-record, at least one said function-unit to have access to said object document comprises:
comparing the frequency-numbers in said third authorization-record to a criteria-frequency-number, to identify each said function-unit which has been authorized for at least a frequency represented by said criteria-frequency-number to have access to the documents including said crucial key word code, whereby the identified function-unit is selected to have access to said object document.

6. The method according to claim 1 wherein said access-authorization process further comprises:
forming a list to contain each said authorized function-unit;
requesting a response of said authorized function-unit to said object document; and
modifying said list according to said response.

7. The method according to claim 1 wherein said access-authorization process further comprises at least two of the following three steps (a), (b), and (c), in addition to step (d):
(a) performing a first mathematical operation between a provider weight value and said frequency-numbers included in said first authorization-record to obtain a group of provider-based authorization-reference values respectively corresponding to different ones of said function-units;
(b) performing a first mathematical operation between a category weight value and said frequency-numbers included in said second authorization-record to obtain a group of category-based authorization-reference values respectively corresponding to different ones of said function-units;
(c) performing a first mathematical operation between a crucial-key-word weight value and said frequency-numbers included in said third authorization-record to obtain a group of crucial-key-word-based authorization-reference values respectively corresponding to different ones of said function-units;
(d) selecting, according to at least two of the three groups of said authorization-reference values, at least one said function-unit to have access to said object document.

8. The method according to claim 7 wherein said first mathematical operation is multiplication.

9. The method according to claim 7 wherein step (d) comprises:
performing a second mathematical operation between said authorization-reference values which are respectively in different ones of said at least two of the three groups and correspond to the same one of said function-units, to obtain a group of compound-reference values respectively corresponding to different ones of said function-units; and
comparing said compound-reference values with a compound-reference-criteria value to identify each said function-unit corresponded by one said compound-reference value larger than said compound-reference-criteria value, whereby the identified function-unit is selected to have access to said object document.

10. The method according to claim 9 wherein said second mathematical operation is addition.

11. The method according to claim 7 wherein step (d) comprises:
performing a second mathematical operation between said authorization-reference values which are respectively in different ones of said at least two of the three groups and correspond to the same one of said function-units, to obtain a group of compound-reference values respectively corresponding to different ones of said function-units; and
identifying each said function-unit corresponded by one said compound-reference value which, in order of magnitude among all said compound-reference value, is within a compound-reference-criteria range, whereby the identified function-unit is selected to have access to said object document.

12. The method according to claim 9 wherein the sum of said weight values in said at least two of three steps (a), (b), and (c) is one.

13. The method according to claim 1 further comprising a category-classification process including:
identifying at least a key word code of said object document; and
designating said known category according to the identified key word code.

14. The method according to claim 13 wherein identifying at least a key word code of said object document, comprises:
counting the frequency each word code of said object document appears in said object document, to obtain an appearing frequency of each word code of said object document;
designating an arbitrary word code of said object document as a candidate key word code if the appearing frequency of said arbitrary word code meets a reference condition; and
searching a key-word-reference database for a reference code corresponding to said candidate key word code, and determining, in case said reference code is searched out, whether or not said candidate key word code is the key word code according to an attribute of said reference code.

15. The method according to claim 14 wherein said reference condition is such that said arbitrary word code is designated as a candidate key word code if the appearing frequency of said arbitrary word code is larger than a key-word-criteria value.

16. The method according to claim 15 wherein said key-word-criteria value is the average of the appearing frequencies of all the word codes of said object document.

17. The method according to claim 14 wherein said reference condition is such that the arbitrary word code is designated as a candidate key word code if the appearing frequency of the arbitrary word code in order of magnitude among said appearing frequencies of all the word codes of said object document is within a frequency-order-criteria-range.

18. The method according to claim 14 wherein the reference code corresponding to said candidate key word code includes said candidate key word code and an attribute, and said candidate key word code is determined to be a key word code if the attribute of said reference code is represented by a first symbol.

19. The method according to claim 14 wherein the reference code corresponding to said candidate key word code includes said candidate key word code and an attribute, and said candidate key word code is determined to be a key word code unless the attribute of said reference code is represented by a second symbol.

20. The method according to claim 14 wherein said key-word-reference database includes a key-word-code list and a non-key-word-code list, said candidate key word code is determined to be a key word code if said candidate key word code is on said key-word-code list, and determined to be not a key word code if said candidate key word code is on said non-key-word-code list.

21. The method according to claim 13 wherein designating said known category comprises:
searching a key-word-code-to-category-mapping table for a category-code corresponding to the identified key word code, whereby said known category is designated said category-code.

22. The method according to claim 21 wherein designating said known category according to the identified key word code, further comprises:
notifying said known document-issuer (or document-provider) if more than one category-code is searched out of said key-word-code-to-category-mapping table to correspond to the identified key word code.

23. The method according to claim 1 wherein the frequency one of said function-units has been authorized to have access to the documents provided by said known document-issuer, is the times the one of said function-units has been authorized to have access to the documents provided by said known document-issuer.

24. The method according to claim 1 wherein the frequency one of said function-units has been authorized to have access to the documents provided by said known document-issuer, is a first times-number divided by a second times-number, with said first times-number being the times the one of said function-units has been authorized to have access to the documents provided by said known document-issuer, and said second times-number being the sum of the times that all said function-units have been authorized to have access to the documents provided by said known document-issuer.

25. A method for managing information including word codes, comprising an access-authorization process for authorizing, according to a reference-file, at least one of multiple function-units to be an authorized function-unit having access to an object document including plural word codes, said access-authorization process comprising at least one of the following three sub-processes:
identifying a document-issuer-code from said object document, searching said reference-file for a first authorization-record including the frequency-numbers each representing the frequency that a different one of said function-units has been authorized to have access to the documents including said document-issuer-code, and selecting, according to said first authorization-record, at least one said function-unit to be said authorized function-unit;
identifying a category-code from said object document, searching said reference-file for a second authorization-record including the frequency-numbers each representing the frequency that a different one of said function-units has been authorized to have access to the documents including said category-code, and selecting, according to said second authorization-record, at least one said function-unit to be said authorized function-unit; and
identifying at least a crucial key word code from said object document, searching said reference-file for a third authorization-record including the frequency-numbers each representing the frequency that a different one of said function-units has been authorized to have access to the documents including said crucial key word code, and selecting, according to said third authorization-record, at least one said function-unit to be said authorized function-unit.

26. An apparatus applied to an information management system in which at least one of multiple function-units is selected to be an authorized function-unit having access to an object document that includes word codes, is in a known category, and is provided by a known document-issuer, said apparatus comprising a data-storage portion having a database residing thereon, said database comprising at least one of the following two authorization-records:
a first authorization-record including the frequency-numbers each representing the frequency that a different one of said function-units has been selected to have access to the documents provided by said known document-issuer; and
a second authorization-record including the frequency-numbers each representing the frequency that a different one of said function-units has been selected to have access to the documents in said known category.

27. The apparatus according to claim 26 further comprising an operational portion for selecting, according to at least one of said two authorization-records, at least one of said function-units to be said authorized function-unit having access to the object document.

28. The apparatus according to claim 26 wherein said database further comprises a third authorization-record including the frequency-numbers each representing the frequency that a different one of said function-units has been selected to have access to the documents including at least a crucial key word code of said object document.

29. The apparatus according to claim 28 further comprises an operational portion for selecting, according to at least two of said first, second, and third authorization-records, at least one of said function-units to be said authorized function-unit having access to the object document.

30. The apparatus according to claim 26 wherein said data-storage portion is a memory readable by said operational portion.
